(19) United States
(12) Patent Application Publication
(10) Pub. No.: US 2022/0162426 A1
(43) Pub. Date: May 26, 2022

(54) Copolymer, Copolymer Composition, and Rubber Composition

(71) Applicant: Asahi Kasei Kabushiki Kaisha, Tokyo (JP)

(72) Inventors: Atsushi Yasumoto, Tokyo (JP); Daigo Matsuoka, Tokyo (JP)

(73) Assignee: Asahi Kasei Kabushiki Kaisha, Tokyo (JP)

(21) Appl. No.: 17/534,757

(22) Filed: Nov. 24, 2021

(30) Foreign Application Priority Data
Nov. 25, 2020 (JP) 2020-195284

(51) Int. Cl. C08L 9/06; C08C 19/02; C08C 19/22; C08C 19/25; C08K 5/5415; C08K 5/5445; C08K 5/54; C08K 5/3445; C08K 3/04; C08K 3/36; B60C 1/00

(52) U.S. Cl. CPC C08L 9/06; C08C 19/02; C08C 19/22; C08C 19/25; C08K 5/5415; B60C 1/0016; C08K 5/5406; C08K 5/3445; C08K 3/04; C08K 3/36; C08K 5/5445

(57) ABSTRACT

The copolymer contains an aromatic vinyl monomer unit, and structural units represented by the following formulas (1) to (4), and, based on 100% by mass of a total amount of these structural units, a content C1 of the formula (1) is 0% by mass or more and 3% by mass or less; a content C2 of the formula (2) is 2% by mass or more and less than 20% by mass; a content C3 of the formula (3) is 4% by mass or more and 80% by mass or less; a content C4 of the formula (4) is 2% by mass or more and 80% by mass or less; and a total of the contents C1 and C2 is 3% by mass or more and less than 20% by mass:

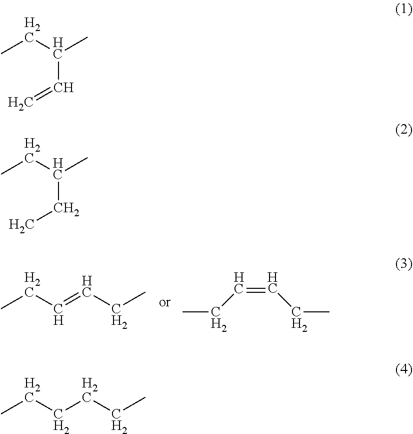

### BACKGROUND OF THE INVENTION

### Field of the Invention

The present invention relates to a copolymer, a copolymer composition, and a rubber composition.

### Description of the Related Art

In recent years, from the viewpoint of reduction of an environmental load, examinations have been made for improving low fuel consumption performance by reducing the weight of a tire, and a rubber material used in a tread of a tire is required to be further improved in tensile strength and tensile elongation, namely, breaking strength, elongation at break, and abrasion resistance.

Examples of a method for improving breaking strength, elongation at break, and abrasion resistance of a rubber material include a method in which a molecular weight of a conjugated diene-based polymer contained in the rubber material is increased, and a method in which a hydrogenated conjugated diene-based polymer is contained in the rubber material.

When the molecular weight of the conjugated diene-based polymer is increased or a hydrogenated conjugated diene-based polymer is contained in the rubber material, however, the viscosity of the resultant rubber material is increased, and hence there arises a problem that processability in performing vulcanization tends to be deteriorated.

In consideration of these circumstances, in order to improve the break strength, the elongation at break, and the abrasion resistance without impairing the processability of the rubber material, a technique using a hydrogenated conjugated diene-based polymer, or a technique using a hydrogenated conjugated diene-based polymer composition obtained by kneading a conjugated diene-based polymer having a high hydrogenation rate and a non-conjugated diene-based polymer have been conventionally proposed.

For example, Japanese Patent Laid-Open No. 8-120119, International Publication No. WO2014/133097, and International Publication No. WO2018/062473 propose the technique using a hydrogenated conjugated diene-based polymer, and the technique using a hydrogenated conjugated diene-based polymer composition.

### SUMMARY OF THE INVENTION

### Technical Problem

A hydrogenated conjugated diene-based polymer and a hydrogenated conjugated diene-based polymer composition conventionally proposed as described above have a problem that their strengths are not sufficiently high. In addition, since they have a high viscosity, they have problems that surface coarseness is caused or sheet breakage is caused when formed into a sheet after kneading with a filler such as silica, and that processability in producing a vulcanizate therefrom tends to be deteriorated.

Accordingly, an object of the present invention is to provide a copolymer, a copolymer composition, and a rubber composition very excellent in processability in producing a vulcanizate therefrom and capable of providing a vulcanizate excellent in breaking strength and elongation at break.

### Solution to Problem

The present inventors have made earnest studies to solve the problems of the conventional techniques, and as a result, have found that a copolymer containing an aromatic vinyl monomer unit and specific structural units in prescribed amounts is very excellent in processability in producing a vulcanizate therefrom, and the resultant vulcanizate is excellent in breaking strength and elongation at break, and thus, the present invention has been accomplished.

Specifically, the present invention provides the following:

[1] A copolymer comprising an aromatic vinyl monomer unit, and structural units respectively represented by the following formulas (1) to (4),

wherein, based on 100% by mass of a total amount of the structural units represented by the following formulas (1) to (4), a content C1 of the structural unit represented by the formula (1) is 0% by mass or more and 3% by mass or less, a content C2 of the structural unit represented by the formula (2) is 2% by mass or more and less than 20% by mass, a content C3 of the structural unit represented by the formula (3) is 4% by mass or more and 80% by mass or less, a content C4 of the structural unit represented by the formula (4) is 2% by mass or more and 80% by mass or less, and a total content of the content C1 and the content C2 is 3% by mass or more and less than 20% by mass:

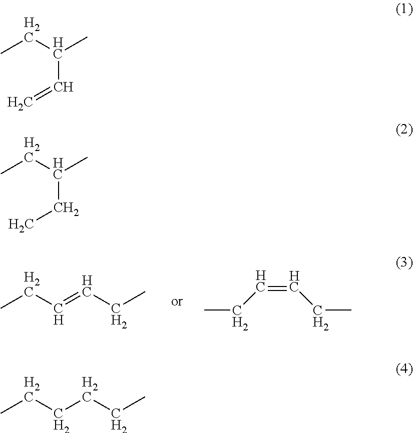

[2] The copolymer according to [1] described above, comprising 5.0% by mass or less of a chained aromatic vinyl monomer containing 8 or more chained aromatic vinyl monomer units.

[3] The copolymer according to [1] or [2] described above, comprising 5% by mass or more and 60% by mass or less of the aromatic vinyl monomer unit.

[4] The copolymer according to any one of [1] to [3] described above, wherein in the structural unit represented by the formula (3), a content of a trans bond is larger than a content of a cis bond by 2% by mass or more and 30% by mass or less.

[5] The copolymer according to any one of [1] to [4] described above, wherein a sum of the content C2 of the structural unit represented by the formula (2) and the content C4 of the structural unit represented by the formula (4) is 30% by mass or more and 85% by mass or less.

[6] The copolymer according to any one of [1] to [5] described above, having a weight average molecular weight measured by gel permeation chromatography (GPC) of 100,000 or more and 1,000,000 or less.

[7] The copolymer according to any one of [1] to [6] described above, having a modification ratio of 30% or more and 99% or less.

[8] The copolymer according to any one of [1] to [7] described above, having a silicon content of 30 to 200 ppm.

[9] The copolymer according to any one of [1] to [8] described above, wherein the contents C1 to C4 of the structural units respectively represented by the formulas (1) to (4) satisfy the following formula (A):

0.2<(C2+C4)/(C1+C2+C3+C4)<0.85 Formula (A):

[10] A copolymer composition comprising 100 parts by mass of the copolymer according to any one of [1] to [9] described above; and 1 to 60 parts by mass of a rubber softener.

[11] A rubber composition comprising a rubber component, and 5.0 parts by mass or more and 150 parts by mass or less of a filler based on 100 parts by mass of the rubber component, wherein the rubber component contains 10 parts by mass or more of the copolymer according to any one of [1] to [9] described above or the copolymer composition according to [10] described above based on 100 parts by mass of a total amount of the rubber component.

### Advantageous Effect of Invention

According to the present invention, a copolymer excellent in processability in producing a vulcanizate therefrom, and capable of providing a vulcanizate excellent in breaking strength and elongation at break can be obtained.

### DETAILED DESCRIPTION OF THE PREFERRED EMBODIMENT

Now, an embodiment for practicing the present invention (hereinafter referred to as the “present embodiment”) will be described in detail.

It is noted that the following present embodiment is merely an example for describing the present invention and the present invention is not limited to the following description but may be variously modified within the scope thereof.

[Copolymer]

A copolymer of the present embodiment is a copolymer containing an aromatic vinyl monomer unit, and structural units respectively represented by the following formulas (1) to (4), and, based on 100% by mass of a total amount of the structural units represented by the following formulas (1) to (4), a content C1 of the structural unit represented by the formula (1) is 0% by mass or more and 3% by mass or less, a content C2 of the structural unit represented by the formula (2) is 2% by mass or more and less than 20% by mass, a content C3 of the structural unit represented by the formula (3) is 4% by mass or more and 80% by mass or less, a content C4 of the structural unit represented by the formula (4) is 1% by mass or more and 80% by mass or less, and a total content of the content C1 and the content C2 is 3% by mass or more and less than 20% by mass:

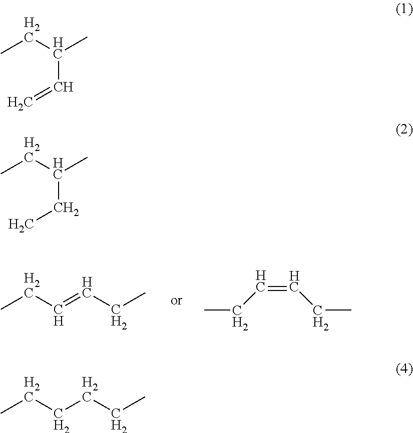

Since the contents C1 to C4 of the structural units represented by the formulas (1) to (4) are specified to the above-described specific ranges, processability in producing a vulcanizate therefrom tends to be very excellent, and the resultant vulcanizate tends to be excellent in breaking strength and elongation at break.

In the copolymer of the present embodiment, the structural unit represented by the formula (1) corresponds to, for example, a 1,2-vinyl bond unit of a conjugated diene monomer unit, and is not especially limited in the raw material thereof as long as it is the same as the structural unit represented by the formula (1).

The content, in the copolymer of the present embodiment, of the structural unit represented by the formula (1) is expressed as C1.

Based on 100% by mass of the total amount of the structural units represented by the formulas (1) to (4), the content C1 is 0% by mass or more and 3% by mass or less, preferably 0.2% by mass or more and 2.6% by mass or less, and more preferably 0.4% by mass or more and 2.4% by mass or less. If the content C1 falls in this range, a vulcanizate obtained from the copolymer of the present embodiment tends to be excellent in breaking strength and elongation at break.

The structural unit represented by the formula (2) corresponds to, for example, a hydrogenated 1,2-vinyl bond unit of a conjugated diene monomer unit, and is not especially limited in the raw material thereof as long as it is the same as the structural unit represented by the formula (2).

The content, in the copolymer of the present embodiment, of the structural unit represented by the formula (2) is expressed as C2.

Based on 100% by mass of the total amount of the structural units represented by the formulas (1) to (4), the content C2 is 2% by mass or more and 20% by mass or less, preferably 4% by mass or more and 18% by mass or less, more preferably 4% by mass or more and 16% by mass or less, and further preferably 5% by mass or more and 16% by mass or less. If the content C2 falls in this range, a vulcanizate obtained from the copolymer of the present embodiment tends to be excellent in breaking strength and elongation at break.

The structural unit represented by the formula (3) corresponds to, for example, a 1,4-cis bond unit and a 1,4-trans bond unit of a conjugated diene monomer unit, and is not especially limited in the raw material thereof as long as it is the same as the structural unit represented by the formula (3).

The content, in the copolymer of the present embodiment, of the structural unit represented by the formula (3) is expressed as C3.

Based on 100% by mass of the total amount of the structural units represented by the formulas (1) to (4), the content C3 is 4% by mass or more and 80% by mass or less, preferably 5% by mass or more and 75% by mass or less, and more preferably 6% by mass or more and 70% by mass or less. If the content C3 falls in this range, a vulcanizate described below tends to be good in crosslinkability and excellent in processability.

The structural unit represented by the formula (4) corresponds to, for example, an ethylene structure, or a hydrogenated 1,4-cis bond unit and a hydrogenated 1,4-trans bond unit of a conjugated diene monomer unit, and is not especially limited in the raw material thereof as long as it is the same as the structural unit represented by the formula (4).

The content, in the copolymer of the present embodiment, of the structural unit represented by the formula (4) is expressed as C4.

Based on 100% by mass of the total amount of the structural units represented by the formulas (1) to (4), the content C4 is 2% by mass or more and 80% by mass or less, preferably 4% by mass or more and 75% by mass or less, more preferably 5% by mass or more and 70% by mass or less, and further preferably 6% by mass or more and 65% by mass or less. If the content C4 falls in this range, a vulcanizate obtained from the copolymer of the present embodiment tends to be excellent in breaking strength, elongation at break, and mechanical properties.

The contents C1 to C4 of the structural units of the formulas (1) to (4) can be measured by 1H-NMR, and specifically, can be measured by a method described in an example below.

A method for controlling each of the contents C1 to C4 of the structural units of the formulas (1) to (4) to the above-described range is not especially limited, and an example includes a method in which an amount of a polar compound to be added or a polymerization temperature to be employed in polymerization is adjusted to control an amount of a 1,2-vinyl bond in a copolymer before hydrogenation, or to control a hydrogenation rate.

The sum of the content C1 of the structural unit represented by the formula (1) and the content C2 of the structural unit represented by the formula (2) is 3% by mass or more and less than 20% by mass, preferably 4% by mass or more and 18% by mass or less, and more preferably 5% by mass or more and 16% by mass or less from the viewpoint of balance between processability in producing a vulcanizate therefrom and breaking strength or elongation at break of the vulcanizate.

In the copolymer of the present embodiment, the structural unit represented by the formula (3) is a 1,4-cis bond and a 1,4-trans bond, and from the viewpoint of processability in producing a vulcanizate, a content of the trans bond is larger than a content of the cis bond by preferably 2% by mass or more and 30% by mass or less, more preferably 3% by mass or more and 26% by mass or less, and further preferably 4% by mass or more and 24% by mass or less.

Here, the contents of the 1,4-cis bond and the 1,4-trans bond can be measured by ¹³C-NMR. Specifically, the contents can be measured by a method described in the example below.

The contents of the 1,4-cis bond and the 1,4-trans bond in the structural unit represented by the formula (3) can be controlled to fall in the above-described range by adjusting the type of a polymerization initiator described later, and the type and the amount to be added of the polar compound.

In the copolymer of the present embodiment, the contents C1 to C4 of the structural units represented by the formulas (1) to (4) preferably satisfy the following formula (A):

0.2<(C2+C4)/(C1+C2+C3+C4)<0.85 Formula (A):

In the formula (A), the denominator, (C1+C2+C3+C4) indicates a pattern of the bonding mode of a conjugated diene monomer unit in the copolymer of the present embodiment, and the numerator, (C2+C4) indicates a unit not containing a double bond but consisting of a single bond. Therefore, the formula (A) indicates a hydrogenation rate of the conjugated diene monomer unit in the copolymer, and as the hydrogenation rate is higher, the contents C2 and C4 are increased.

From the viewpoints of heat resistance, ozone resistance, vulcanizability, and viscosity control, it is effective to control the ratio (C2+C4)/(C1+C2+C3+C4) in addition to the contents C1 to C4 of the structural units represented by the formulas (1) to (4).

Specifically, from the viewpoint of heat resistance and ozone resistance, the lower limit of the ratio in the formula (A) is preferably 0.2, more preferably 0.25, further preferably 0.3, and still further preferably 0.32.

From the viewpoints of vulcanizability and inhibiting viscosity increase caused by a crystal component, the upper limit of the ratio in the formula (A) is preferably 0.85, more preferably 0.83, further preferably 0.80, and still further preferably 0.78.

The ratio of the formula (A) can be controlled to fall in the above-described range by adjusting the hydrogenation rate of the copolymer.

In the copolymer of the present embodiment, the sum of the content C2 of the structural unit represented by the formula (2) and the content C4 of the structural unit represented by the formula (4) indicates a content of a saturated bond, and from the viewpoints of breaking strength and elongation at break of a vulcanizate and processability in producing the vulcanizate, the sum is preferably 30% by mass or more and 85% by mass or less, more preferably 32% by mass or more and 80% by mass or less, and further preferably 34% by mass or more and 75% by mass or less.

(Conjugated Diene Compound)

In the copolymer of the present embodiment, the structural units represented by the formulas (1) to (4) are preferably structural units derived from a conjugated diene compound (hereinafter also referred to as the “conjugated diene monomer”).

Examples of the conjugated diene compound include, but are not limited to, 1,3-butadiene, isoprene, 2,3-dimethyl-1,3-butadiene, 1,3-pentadiene, 3-methyl-1,3-pentadiene, 1,3-hexadiene, and 1,3-heptadiene. Among these, 1,3-butadiene and isoprene are preferred, and 1,3-butadiene is more preferred from the viewpoint of industrial availability.

One of these may be singly used, or two or more of these may be used together.

The copolymer of the present embodiment contains a structural unit derived from an aromatic vinyl compound (hereinafter also referred to as the “aromatic vinyl monomer unit”).

Examples of the aromatic vinyl compound include, but are not limited to, styrene, p-methylstyrene, α-methylstyrene, vinyl ethyl benzene, vinyl xylene, vinyl naphthalene, and diphenyl ethylene.

Among these, styrene is preferred from the viewpoint of industrial availability.

One of these may be singly used, or two or more of these may be used together.

The copolymer of the present embodiment is preferably a hydrogenated product of a copolymer of a conjugated diene compound and an aromatic vinyl compound (hereinafter also referred to as the “conjugated diene-aromatic vinyl copolymer”).

In the copolymer of the present embodiment, a content of the aromatic vinyl monomer unit is preferably 5% by mass or more, more preferably 8% by mass or more, and further preferably 10% by mass or more from the viewpoints of breaking strength of a vulcanizate and crystallinity reduction. On the other hand, from the viewpoints of crosslinkability and processability in producing a vulcanizate, the content of the aromatic vinyl monomer unit is preferably 60% by mass or less, more preferably 55% by mass or less, and further preferably 50% by mass or less.

The content of the aromatic vinyl monomer unit in the copolymer of the present embodiment can be controlled to fall in the above-described numerical range by adjusting the amount of an aromatic vinyl monomer to be added in a polymerizing step.

Here, the content of the aromatic vinyl monomer unit can be measured by ¹H-NMR. Specifically, it can be measured in accordance with a method described in the example below.

If the copolymer of the present embodiment is a hydrogenated product of a conjugated diene-aromatic vinyl copolymer, from the viewpoint of improving fuel efficiency, a larger proportion of an aromatic vinyl monomer unit is preferably present singly.

Specifically, if the copolymer is a butadiene-styrene copolymer, when the copolymer is decomposed by employing a method through ozonolysis known as a method of Tanaka et al., (Polymer, 22, 1721 (1981)) to analyze an aromatic vinyl monomer unit distribution by GPC, it is preferable that the amount of an isolated aromatic vinyl monomer unit is 40% by mass or more based on the total amount of aromatic vinyl monomer units contained in the copolymer, and that the amount of a chain styrene structure containing 8 or more chained aromatic vinyl monomer units is preferably 5.0% by mass or less, more preferably 4.0% by mass or less, and further preferably 3.5% by mass or less.

If the aromatic vinyl monomer is styrene, it is preferable that the amount of isolated styrene (the amount of styrene present in a polymer chain not in the form of a chain), based on the total amount of bound styrene, obtained by analysis of a styrene chain distribution is 40% by mass or more, and that the amount of a chain styrene structure containing 8 or more chained styrene is 5.0% by mass or less, more preferably 4.0% by mass or less, and further preferably 3.5% by mass or less.

In this case, a resultant vulcanizate attains a low hysteresis loss, which is preferable.

A content of the chained aromatic vinyl monomer in the copolymer of the present embodiment can be controlled to fall in the above-described numerical range by adjusting, in the polymerizing step, a method for adding an aromatic vinyl compound and a conjugated diene compound, or the amount of the polar compound to be added described below.

(Hydrogenation Reaction)

The copolymer of the present embodiment may be a hydrogenated copolymer having been subjected to a hydrogenating step. The hydrogenated copolymer is obtained by hydrogenating a conjugated diene portion of the copolymer described below.

A method for hydrogenating the conjugated diene portion of the copolymer is not especially limited, and any of known methods can be employed.

As the method for hydrogenating the copolymer, for example, a method of blowing gaseous hydrogen into a polymer solution in the presence of a catalyst can be employed.

Examples of the catalyst include, but are not limited to, heterogeneous catalysts such as a catalyst containing a noble metal supported on a porous inorganic substance; and homogenous catalysts such as a catalyst obtained by reacting a solubilized salt of nickel, cobalt or the like with organic aluminum or the like, and a catalyst using metallocene such as titanocene.

Among these catalysts, from the viewpoint that a mild hydrogenation condition can be selected, a titanocene catalyst is preferably used.

The hydrogenation reaction may be performed as either of a batch process and a continuous process, or a combination of these.

If the copolymer of the present embodiment is a hydrogenated copolymer, a hydrogenation rate of a structural unit derived from a conjugated diene compound (for example, butadiene) is preferably 30% or more and less than 99%, more preferably 30% or more and less than 96%, further preferably 30% or more and less than 93%, still further preferably 30% or more and less than 90%, and still further preferably 32% or more and less than 90%.

If the hydrogenation rate of the structural unit derived from a conjugated diene compound is 30% or more, the copolymer of the present embodiment is excellent in breaking strength and elongation at break obtained in the form of a vulcanizate, and if the hydrogenation rate of the structural unit derived from a conjugated diene compound is less than 99%, the copolymer of the present embodiment is excellent in breaking strength and low fuel consumption performance obtained in the form of a vulcanizate because a crosslink density obtained after vulcanization is increased.

The hydrogenation rate can be controlled in accordance with the amount of hydrogen to be added to the structural unit derived from a conjugated diene compound.

A hydrogenation reaction temperature is not especially limited, and preferably 60 to 105° C., and more preferably 70 to 100° C.

The hydrogenation rate can be measured by 1H-NMR.

A weight average molecular weight of the copolymer of the present embodiment is preferably 100,000 or more and 1,000,000 or less, more preferably 120,000 or more and 900,000 or less, further preferably 150,000 or more and 800,000 or less, and still further preferably 200,000 or more and 700,000 or less from the viewpoint of attaining good low fuel consumption performance of a vulcanizate.

Also from the viewpoints of adhesiveness in production, such as suppression of adhesion of a copolymer obtained after desolvation to a wall or the like of a drier, and moldability of a rubber bale, the weight average molecular weight of the copolymer of the present embodiment is preferably within the above-described range.

The weight average molecular weight can be controlled to fall in the above-described numerical range by, for example, adjusting an amount of a polymerization initiator to be used.

The weight average molecular weight of the copolymer of the present embodiment can be measured by a method described in the example below.

The copolymer of the present embodiment has a silicon content of preferably 30 ppm or more, more preferably 33 ppm or more, and further preferably 35 ppm or more from the viewpoint of balance between low fuel consumption performance and wet grip performance. On the other hand, the silicon content is preferably 200 ppm or less, more preferably 180 ppm or less, and further preferably 160 ppm or less from the viewpoint of processability.

The silicon content can be controlled to fall in the above-described numerical range by adjusting the amount to be added and the type of a coupling agent or a modifier having a nitrogen atom-containing group described below.

(Coupled Copolymer)

The copolymer of the present embodiment is preferably a coupled copolymer obtained by subjecting an active end of a copolymer obtained through a polymerizing step, and a branching step using a branching agent, if necessary, to a coupling reaction using a tri- or higher functional reactive compound (hereinafter also referred to as the “coupling agent”).

In a coupling step, one end of active ends of the copolymer is subjected to a coupling reaction using a prescribed coupling agent or a modifier having a nitrogen atom-containing group to obtain the copolymer.

(Coupling Agent)

The coupling agent used in the coupling step may have any structure as long as it is a tri- or higher functional reactive compound, and is preferably a tri- or higher functional reactive compound having a silicon atom.

The copolymer of the present embodiment preferably contains a nitrogen atom. A copolymer containing a nitrogen atom can be obtained, for example, by performing a coupling reaction using a modifier having a nitrogen atom-containing group described below.

(Modifier Having Nitrogen Atom-Containing Group)

The copolymer of the present embodiment is more preferably a copolymer obtained by subjecting an active end of a copolymer obtained through the polymerizing step, and the branching step using a branching agent, if necessary, to a coupling reaction using a tri- or higher functional reactive compound having a nitrogen atom-containing group (hereinafter also referred to as the “modifier having a nitrogen atom-containing group”).

In this case, the copolymer is obtained, in the coupling step, preferably by subjecting one end of active ends of the copolymer to a coupling reaction using a modifier having a nitrogen atom-containing group.

When a copolymer obtained by coupling using a modifier having a nitrogen atom-containing group is formed into a rubber composition with a filler such as silica blended, dispersibility of the filler such as silica is good, and processability of the rubber composition with the filler blended is good. In addition, when the rubber composition is formed into a vulcanizate, abrasion resistance and fracture strength are good, and balance between a low hysteresis loss property and wet grip performance tends to be dramatically improved.

Examples of the modifier having a nitrogen atom-containing group include, but are not limited to, an isocyanate compound, an isothiocyanate compound, an isocyanuric acid derivative, a nitrogen group-containing carbonyl compound, a nitrogen atom-containing vinyl compound, and a nitrogen group-containing epoxy compound.

The modifier having a nitrogen atom-containing group preferably has a nitrogen atom-containing functional group, and the nitrogen atom-containing functional group is preferably an amine compound not having active hydrogen, and examples include a tertiary amine compound, a protected amine compound in which the active hydrogen is substituted with a protecting group, an imine compound represented by a general formula, —N═C, and an alkoxysilane compound binding to the nitrogen atom-containing functional group.

(Modification Ratio)

Herein, the term “modification ratio” refers to a mass ratio of a copolymer having a nitrogen atom-containing functional group to a total amount of copolymers.

For example, if the modifier having a nitrogen atom-containing group is reacted with a terminal end of the copolymer, a mass ratio of a copolymer having a nitrogen atom-containing functional group generated with the modifier having a nitrogen atom-containing modifier to a total amount of the copolymer corresponds to a modification ratio.

On the other hand, also if a branch structure is formed in a polymer with a branching agent containing a nitrogen atom, the copolymer to be generated has a nitrogen atom-containing functional group, and therefore, the polymer having such a branch structure is also counted in calculating a modification ratio.

In other words, herein, a total mass ratio of a coupled polymer generated with a modifier having a nitrogen atom-containing group and a polymer having a branch structure generated with a branching agent having a nitrogen atom is referred to as the “modification ratio”.

If the copolymer of the present embodiment has at least one end modified with a modifier having a nitrogen atom-containing group, balance between a low hysteresis loss property and wet grip performance tends to be dramatically improved with retaining processability in forming a rubber composition by blending a filler or the like with the copolymer, and abrasion resistance and fracture strength obtained in forming the rubber composition into a vulcanizate.

The copolymer of the present embodiment has a modification ratio measured by column adsorption GPC (hereinafter also referred to simply as the “modification ratio”) of preferably 30% or more based on the total amount of the copolymer from the viewpoints of processability, abrasion resistance, fracture strength, and balance between a low hysteresis loss property and wet grip performance.

The modification ratio is preferably 60% or more, more preferably 65% or more, further preferably 70% or more, and still further preferably 80% or more. The upper limit of the modification ratio is not especially limited, and is, for example, 99% or less.

The modification ratio can be measured by chromatography capable of separating a modified component having a nitrogen atom-containing functional group from an unmodified component.

As a method using chromatography, a method (column adsorption GPC) using a column for gel permeation chromatography using, as a filler, a polar material such as silica adsorbing a nitrogen atom-containing functional group, for performing quantitative determination using an internal standard of a non-adsorbed component can be employed.

More specifically, the modification ratio is obtained by measuring an amount of adsorption onto a silica column based on a difference between a chromatogram measured by using a polystyrene-based gel column and a chromatogram measured by using a silica-based column obtained from a sample solution containing a sample and low molecular weight internal standard polystyrene.

More specifically, the modification ratio is measured by a method described in the examples below.

In the copolymer of the present embodiment, the modification ratio can be controlled by adjusting the amount of the modifier to be added and a reaction method, and thus can be controlled to 30% or more and 99% or less.

For example, a method in which polymerization is performed by using, as a polymerization initiator, an organic lithium compound, described later, having at least one nitrogen atom in a molecule, a method in which a monomer having at least one nitrogen atom in a molecule is copolymerized, and a method in which a modifier having a structural formula described later is used are combined, and polymerization conditions are controlled, and thus, the modification ratio can be obtained.

[Method for Producing Copolymer]

The copolymer of the present embodiment can be produced by performing a polymerizing step using a prescribed polymerization initiator, and preferably, a coupling reaction step is performed using the above-described coupling agent, and a hydrogenating step may be further performed. More preferably, a branching step using a branching agent may be performed before the coupling reaction step.

(Polymerizing Step)

As the polymerization initiator used in the polymerizing step, for example, an organomonolithium compound can be used.

An example of the organomonolithium compound includes, but is not limited to, an organomonolithium compound of a low molecular weight compound or a soluble oligomer.

Examples of the organomonolithium compound include, with respect to a bonding mode between an organic group and lithium thereof, a compound having a carbon-lithium bond, a compound having a nitrogen-lithium bond, and a compound having a tin-lithium bond.

An amount of the organomonolithium compound used as the polymerization initiator is preferably determined on the basis of the structure of a target copolymer and the molecular weight of the copolymer.

A ratio of the amount of a monomer such as a conjugated diene compound to be used to the amount of the polymerization initiator to be used relates to the degree of polymerization. In other words, there is a tendency that it relates to the number average molecular weight and/or the weight average molecular weight.

Accordingly, in order to increase the molecular weight of the copolymer, adjustment may be made to reduce the amount of the polymerization initiator to be used, and in order to reduce the molecular weight, the adjustment may be made to increase the amount of the polymerization initiator to be used.

If the organomonolithium compound used as the polymerization initiator is used as one method for introducing a nitrogen atom into the copolymer, the organomonolithium compound is preferably an alkyl lithium compound having a substituted amino group or dialkylamino lithium.

In this case, a copolymer having, at a polymerization starting end, a nitrogen atom of an amino group is obtained.

The substituted amino group refers to an amino group having no active hydrogen or having a structure in which active hydrogen is protected.

Examples of an alkyl lithium compound containing an amino group having no active hydrogen include, but are not limited to, 3-dimethylaminopropyl lithium, 3-diethylaminopropyl lithium, 4-(methylpropylamino)butyl lithium and 4-hexamethyleneiminobutyl lithium.

Examples of an alkyl lithium compound containing an amino group having a structure in which active hydrogen is protected include, but are not limited to, 3-bistrimethylsilylaminopropyl lithium and 4-trimethylsilylmethylaminobutyl lithium.

Examples of the dialkylamino lithium include, but are not limited to, lithium dimethylamide, lithium diethylamide, lithium dipropylamide, lithium dibutylamide, lithium di-n-hexylamide, lithium diheptylamide, lithium diisopropylamide, lithium dioctylamide, lithium-di-2-ethylhexylamide, lithium didecylamide, lithium ethylpropylamide, lithium ethylbutylamide, lithium ethylbenzylamide, lithium methylphenetylamide, lithium hexamethyleneimide, lithium pyrrolidide, lithium piperidide, lithium heptamethyleneimide, lithium morpholide, 1-lithioazacyclooctane, 6-lithio-1,3,3-trimethyl-6-azabicyclo[3.2.1] octane, and 1-lithio-1,2,3,6-tetrahydropyridine.

Such an organomonolithium compound having a substituted amino group can be reacted with a small amount of a polymerizable monomer, such as 1,3-butadiene, isoprene or styrene, to be used as an organomonolithium compound of a soluble oligomer.

The organomonolithium compound used as the polymerization initiator is preferably an alkyllithium compound from the viewpoints of industrial availability and controllability of the polymerization reaction. In this case, a copolymer having an alkyl group at a polymerization starting end can be obtained.

Examples of the alkyl lithium compound include, but are not limited to, n-butyllithium, sec-butyllithium, tert-butyllithium, n-hexyllithium, benzyllithium, phenyllithium, and stilbene lithium.

From the viewpoint of the industrial availability and the controllability of the polymerization reaction, the alkyl lithium compound is preferably n-butyllithium or sec-butyllithium.

One of the above-described organomonolithium compounds used as the polymerization initiator may be singly used, or two or more of these may be used together. Alternatively, another organic metal compound may be used together.

Examples of another organic metal compound include alkaline earth metal compounds, alkaline metal compounds excluding the above-described organomonolithium compounds, and other organic metal compounds.

Examples of the alkaline earth metal compounds include, but are not limited to, organic magnesium compounds, organic calcium compounds and organic strontium compounds. Other examples include compounds of alkoxides, sulfonates, carbonates and amides of alkaline earth metals.

Examples of the organic magnesium compounds include dibutyl magnesium and ethyl butyl magnesium.

Examples of the other organic metal compounds include organic aluminum compounds.

Examples of a polymerization reaction mode employed in the polymerizing step include, but are not limited to, batch and continuous polymerization reaction modes.

In the continuous mode, one reactor or two or more connected reactors can be used. As a reactor for the continuous mode, for example, a tank or tubular reactor equipped with a stirrer can be used. In the continuous mode, it is preferable that a monomer, an inert solvent and a polymerization initiator are continuously fed to the reactor, a polymer solution containing a polymer is obtained in the reactor, and the polymer solution is continuously discharged.

In the batch mode, for example, a tank reactor equipped with a stirrer is used. It is preferable, in the batch mode, that a monomer, an inert solvent and a polymerization initiator are fed to the reactor, the monomer is continuously or intermittently additionally fed if necessary during the polymerization, a polymer solution containing a polymer is obtained in the reactor, and the polymer solution is discharged after completing the polymerization.

In the production method for a copolymer of the present embodiment, in order to obtain a copolymer having an active end at a high ratio, the continuous mode in which a polymer is continuously discharged to be supplied to a next reaction in a short period of time is preferably employed.

In the polymerizing step for a copolymer, a monomer is polymerized preferably in an inert solvent.

Examples of the inert solvent include, but are not especially limited to, hydrocarbon-based solvents such as saturated hydrocarbons and aromatic hydrocarbons. Specific examples include aliphatic hydrocarbons such as butane, pentane, hexane and heptane; alicyclic hydrocarbons such as cyclopentane, cyclohexane, methylcyclopentane and methylcyclohexane; aromatic hydrocarbons such as benzene, toluene and xylene; and a hydrocarbon containing a mixture of any of these.

Impurities of allenes and acetylenes are preferably treated with an organic metal compound before the solvent is supplied to the polymerizing step because thus, a copolymer having an active end in a high concentration tends to be obtained, and a modified copolymer having a high modification ratio tends to be obtained.

In the polymerizing step, a polar compound may be added. If a polar compound is added, an aromatic vinyl compound can be randomly copolymerized with a conjugated diene compound. Besides, there is a tendency that the polar compound can be used also as a vinylation agent for controlling a microstructure of a conjugated diene portion. In addition, the addition of the polar compound tends to be advantageous for acceleration of the polymerization reaction and the like.

Examples of the polar compound include, but are not limited to, ethers such as tetrahydrofuran, diethyl ether, dioxane, ethylene glycol dimethyl ether, ethylene glycol dibutyl ether, diethylene glycol dimethyl ether, diethylene glycol dibutyl ether, dimethoxybenzene, and 2,2-bis(2-oxolanyl)propane; tertiary amine compounds such as tetramethylethylenediamine, dipiperidinoethane, trimethylamine, triethylamine, pyridine, and quinuclidine; alkaline metal alkoxide compounds such as potassium-tert-amylate, potassium-tert-butylate, sodium-tert-butylate, and sodium amylate; and phosphine compounds such as triphenylphosphine.

One of these polar compounds may be singly used, or two or more of these may be used together.

The amount of the polar compound to be used is not especially limited but can be selected in accordance with the purpose, and is preferably 0.01 mol or more and 10 mol or less per mole of the polymerization initiator.

Such a polar compound can be used, as a microstructure modifier for a polymer conjugated diene portion, in an appropriate amount in accordance with a desired amount of 1,2-vinyl bound. The polar compound exhibits an effect as a vinylation agent, and at the same time, has a randomizing effect effective in copolymerization between a conjugated diene compound and an aromatic vinyl compound, and can be used for adjusting a distribution of the aromatic vinyl compound or adjusting an amount of a styrene block.

As a method for randomizing a conjugated diene compound and an aromatic vinyl compound, for example, as described in Japanese Patent Laid-Open No. 59-140211, a copolymerization reaction is started with the whole amount of styrene and a part of 1,3-butadiene with the rest of 1,3-butadiene intermittently added during the copolymerization reaction.

In the polymerizing step, a polymerization temperature is preferably a temperature at which the living anionic polymerization proceeds, and from the viewpoint of productivity, is more preferably 0° C. or more, and more preferably 120° C. or less. If such a polymerization temperature is employed, there is a tendency that a reaction amount of the modifier reacted to the active end can be sufficiently attained after completing the polymerization. The polymerization temperature is much further preferably 50° C. or more and 100° C. or less.

(Coupling Step)

A coupling reaction is performed using the coupling agent or the modifier having a nitrogen atom-containing group described above on the active end of the copolymer obtained through the polymerizing step, and the branching step using a prescribed branching agent if necessary.

(Deactivator and Neutralizer)

In the method for producing a copolymer of the present embodiment, a deactivator, a neutralizer or the like may be added, if necessary, to the polymer solution after the coupling step.

Examples of the deactivator include, but are not limited to, water; and alcohols such as methanol, ethanol and isopropanol.

Examples of the neutralizer include, but are not limited to, carboxylic acids such as stearic acid, oleic acid and versatic acid, namely, a mixture of highly branched carboxylic acids having 9 to 11 carbon atoms, mainly 10 carbon atoms; and an aqueous solution of an inorganic acid, and a carbon dioxide gas.

(Stabilizer for Rubber)

In the method for producing a copolymer of the present embodiment, from the viewpoints of preventing gel formation after the polymerization and of improving stability in the processing, a stabilizer for rubber is preferably added to the polymer solution after the polymerizing step or the coupling step.

As the stabilizer for rubber, any of known stabilizers, not limited to the following, can be used, and preferable examples include antioxidants such as 2,6-di-tert-butyl-4-hydroxytoluene (hereinafter also referred to as “BHT”), n-octadecyl-3-(4′-hydroxy-3′,5′-di-tert-butylphenol)propionate, and 2-methyl-4,6-bis[(octylthio)methyl]phenol.

(Desolvation Step)

In the method for producing a copolymer of the present invention, as a method for obtaining the resultant copolymer from the polymer solution, any of known methods can be employed. The method is not especially limited, and examples include a method in which the copolymer is filtered after separating the solvent by steam stripping or the like, and the resultant is dehydrated and dried to obtain the copolymer, a method in which the solution is concentrated in a flushing tank, and the resultant is devolatilized with a bent extruder or the like, and a method in which the solution is directly devolatilized with a drum dryer or the like.

[Copolymer Composition]

A copolymer composition of the present embodiment contains 100 parts by mass of the copolymer of the present embodiment described above, and 1 to 60 parts by mass of a rubber softener.

(Rubber Softener)

From the viewpoint of productivity of the copolymer of the present embodiment and the viewpoint of further improving processability obtained in the form of a rubber composition with a filler or the like blended therein, a rubber softener can be added to the copolymer of the present embodiment if necessary.

The rubber softener is not especially limited, and examples include an extender oil, a liquid rubber, and a resin.

As a method for adding the rubber softener to the copolymer, although not restrictive, a method in which the rubber softener is added to and mixed with a copolymer solution, and the resultant polymer solution containing the rubber softener is desolvated is preferably employed.

Examples of the extender oil used as the rubber softener include an aroma oil, a naphthenic oil and a paraffin oil. Among these oils, from the viewpoint of environmental safety, oil bleeding prevention and wet grip performance, an aroma-alternative oil containing 3% by mass or less of a polycyclic aromatic (PCA) component measured according to the IP 346 method is preferred.

Examples of the aroma-alternative oil include, but are not limited to, TDAE (Threated Distillate Aromatic Extracts), MES (Mild Extraction Solvate) and the like mentioned in Kautschuk Gummi Kunststoffe 52 (12) 799 (1999), and RAE (Residual Aromatic Extracts).

Examples of the liquid rubber used as the rubber softener include, but are not limited to, liquid polybutadiene and liquid styrene-butadiene rubber.

If the liquid rubber is added, not only processability obtained in the form of a rubber composition containing the copolymer and a filler or the like blended therein can be improved but also there is a tendency that abrasion resistance, a low hysteresis loss property and low temperature characteristics obtained in the form of a vulcanizate can be improved because the glass transition temperature of the rubber composition can be shifted to a low temperature side.

Examples of the resin used as the rubber softener include, but are not limited to, an aromatic petroleum resin, a coumarone-indene resin, a terpene-based resin, a rosin derivative (including a wood oil resin), tall oil, a derivative of tall oil, a rosin ester resin, a natural or synthetic terpene resin, an aliphatic hydrocarbon resin, an aromatic hydrocarbon resin, a mixed aliphatic-aromatic hydrocarbon resin, a coumarin-indene resin, a phenol resin, a p-tert-butylphenol-acetylene resin, a phenol-formaldehyde resin, a xylene-formaldehyde resin, a monoolefin oligomer, a diolefin oligomer, a hydrogenated aromatic hydrocarbon resin, a cyclic aliphatic hydrocarbon resin, a hydrogenated hydrocarbon resin, a hydrogenated wood oil resin, a hydrogenated oil resin, and an ester of a hydrogenated oil resin and a monofunctional or polyfunctional alcohol. One of these resins may be singly used, or two or more of these may be used together. When hydrogenated, all unsaturated groups may be hydrogenated, or some may be left not hydrogenated.

If the resin is added, not only processability obtained in the form of a rubber composition containing the copolymer and a filler or the like blended therein can be improved but also there is a tendency that fracture strength obtained in the form of a vulcanizate can be improved, and that wet grip performance can be improved because the glass transition temperature of the rubber composition can be shifted to a high temperature side.

An amount of the extender oil, the liquid rubber or the resin or the like used as the rubber softener to be added is 1 part by mass or more and 60 parts by mass or less, preferably 5 parts by mass or more and 50 parts by mass or less, and more preferably 10 parts by mass or more and 37.5 parts by mass or less based on 100 parts by mass of the copolymer of the present embodiment.

If the rubber softener is added in the amount falling in this range, processability obtained in the form of a rubber composition containing the copolymer and a filler or the like blended therein tends to be good, and fracture strength and abrasion resistance obtained in the form of a vulcanizate tend to be good.

[Rubber Composition]

A rubber composition of the present embodiment contains a rubber component, and 5.0 parts by mass or more and 150 parts by mass or less of a filler based on 100 parts by mass of the rubber component.

From the viewpoint of improving low fuel consumption performance, processability, and abrasion resistance, the rubber component contains 10 parts by mass or more of the copolymer of the present embodiment or the copolymer composition described above based on the total amount (100 parts by mass) of the rubber component.

A filler preferably contains a silica-based inorganic filler.

When the silica-based inorganic filler is dispersed, the rubber composition of the present embodiment tends to be more excellent in processability obtained in producing a vulcanizate therefrom and tends to be more excellent in abrasion resistance and fracture strength obtained in the form of a vulcanizate, and balance between a low hysteresis loss property and wet grip performance.

Also when the rubber composition of the present embodiment is to be used in application to a vulcanized rubber such as a tire, a vehicle component such as an anti-vibration rubber, or shoes, a silica-based inorganic filler is preferably contained.

The rubber composition of the present embodiment can use, in combination with the copolymer, another rubber additive (hereinafter referred to simply as the “rubber additive”) different from the copolymer.

Examples of such a rubber additive include, but are not limited to, a conjugated diene-based polymer or a hydrogenated product thereof, a random copolymer of a conjugated diene-based compound and a vinyl aromatic compound, or a hydrogenated product thereof, a block copolymer of a conjugated diene-based compound and a vinyl aromatic compound, or a hydrogenated product thereof, a non-diene-based polymer and a natural rubber.

Examples of the conjugated diene-based polymer used as the rubber additive include, but are not limited to, a butadiene rubber or a hydrogenated product thereof, an isoprene rubber or a hydrogenated product thereof, styrene-based elastomers such as a styrene-butadiene rubber or a hydrogenated product thereof, and a styrene-butadiene block copolymer or a hydrogenated product thereof, a styrene-isoprene block copolymer or a hydrogenated product thereof, and an acrylonitrile-butadiene rubber or a hydrogenated product thereof.

Examples of the non-diene-based polymer used as the rubber additive include, but are not limited to, olefin-based elastomers such as an ethylene-propylene rubber, an ethylene-propylene-diene rubber, an ethylene-butene-diene rubber, an ethylene-butene rubber, an ethylene-hexene rubber and an ethylene-octene rubber, a butyl rubber, a brominated butyl rubber, an acrylic rubber, a fluorine rubber, a silicone rubber, a chlorinated polyethylene rubber, an epichlorohydrin rubber, an α,β-unsaturated nitrile-acrylic acid ester-conjugated diene copolymer rubber, a urethane rubber and a polysulfide rubber.

Examples of the natural rubber used as the rubber additive include, but are not limited to, smoked sheets of RSS Nos. 3 to 5, SMR and epoxidized natural rubber.

The above-described various rubber additives may be in the form of a modified rubber imparted with a functional group having polarity such as a hydroxyl group or an amino group. If the rubber additive is used for a tire, a butadiene rubber, an isoprene rubber, a styrene-butadiene rubber, a natural rubber and a butyl rubber are preferably used.

The rubber additive has a weight average molecular weight of preferably 2,000 or more and 2,000,000 or less, and more preferably 5,000 or more and 1,500,000 or less from the viewpoint of balance between performance and processing characteristics.

Besides, as the rubber additive, a rubber additive having a low molecular weight, namely, what is called a liquid rubber, can be used. One of these rubber additives may be singly used, or two or more of these may be used together.

If the rubber component contained in the rubber composition of the present embodiment contains the copolymer or the copolymer composition of the present embodiment described above, and the rubber additive, a content ratio (in a mass ratio) of the rubber additive to the copolymer or the copolymer composition is, in terms of (the copolymer or the copolymer composition/rubber additive), preferably 10/90 or more and 100/0 or less, more preferably 20/80 or more and 90/10 or less, and further preferably 50/50 or more and 80/20 or less.

Accordingly, the rubber component contains, based on the total amount (100 parts by mass) of the rubber component, the copolymer or the copolymer composition in an amount of preferably 10 parts by mass or more and 100 parts by mass or less, more preferably 20 parts by mass or more and 90 parts by mass or less, and further preferably 50 parts by mass or more and 80 parts by mass or less.

If the mass ratio of (the copolymer or the copolymer composition/the rubber additive) falls in the above-described range, the rubber composition of the present embodiment tends to be excellent in abrasion resistance and fracture strength obtained in the form of a vulcanizate, and be also excellent in balance between a low hysteresis loss property and wet grip performance.

Examples of the filler contained in the rubber composition of the present embodiment include, but are not limited to, a silica-based inorganic filler, carbon black, a metal oxide, and a metal hydroxide. Among these, a silica-based inorganic filler is preferred.

One of these fillers may be singly used, or two or more of these may be used together.

A content of the filler in the rubber composition of the present embodiment is 5.0 parts by mass or more and 150 parts by mass or less, preferably 20 parts by mass or more and 100 parts by mass or less, and further preferably 30 parts by mass or more and 90 parts by mass or less based on 100 parts by mass of the rubber component containing the above-described copolymer of the present embodiment.

In the rubber composition of the present embodiment, the content of the filler is 5.0 parts by mass or more based on 100 parts by mass of the rubber component from the viewpoint of exhibiting the effect of filler addition, and is 150 parts by mass or less based on 100 parts by mass of the rubber component from the viewpoint of sufficiently dispersing the filler to attain practically sufficient processability and mechanical strength of the rubber composition.

The silica-based inorganic filler is not especially limited, any of known fillers can be used, a solid particle containing SiO₂ or Si₃Al as a constituent unit is preferred, and a solid particle containing SiO₂ or Si₃Al as a principal component of a constituent unit is more preferred. Here, the principal component refers to a component contained in the silica-based inorganic filler in an amount of 50% by mass or more, preferably 70% by mass or more, and more preferably 80% by mass or more.

Examples of the silica-based inorganic filler include, but are not limited to, silica, clay, talc, mica, diatomite, wollastonite, montmorillonite, zeolite and inorganic fibrous substances such as glass fiber. Besides, a silica-based inorganic filler having a hydrophobized surface, or a mixture of a silica-based inorganic filler and an inorganic filler excluding silica can be used. Among these, from the viewpoint of strength and abrasion resistance of the rubber composition, silica and glass fiber are preferred, and silica is more preferred. Examples of the silica include dry silica, wet silica and synthetic silicate silica. Among these silica, wet silica is preferred from the viewpoint that it is excellent in the effect of improving fracture strength of the rubber composition and balance in wet grip performance.

From the viewpoint of obtaining practically good abrasion resistance and fracture strength of the rubber composition of the present embodiment, a nitrogen adsorption specific surface area, obtained by the BET adsorption method, of the silica-based inorganic filler is preferably 100 m²/g or more and 300 m²/g or less, and more preferably 170 m²/g or more and 250 m²/g or less. Besides, a silica-based inorganic filler having a comparatively small specific surface area (of, for example, a specific surface area less than 200 m²/g) and a silica-based inorganic filler having a comparatively large specific surface area (of, for example, 200 m²/g or more) can be used in combination if necessary.

If a silica-based inorganic filler having a comparatively large specific surface area (of, for example, 200 m²/g or more) is used in particular in the rubber composition of the present embodiment, the rubber composition containing the copolymer of the present embodiment tends to be excellent in dispersibility of silica, be effective particularly in improvement of abrasion resistance, and be capable of well-balanced in good fracture strength and a low hysteresis loss property.

A content of the silica-based inorganic filler in the rubber composition of the present embodiment is preferably 5.0 parts by mass or more and 150 parts by mass or less, more preferably 20 parts by mass or more and 100 parts by mass or less based on 100 parts by mass of the rubber component containing the above-described copolymer of the present embodiment. In the rubber composition of the present embodiment, the content of the silica-based inorganic filler is preferably 5.0 parts by mass or more based on 100 parts by mass of the rubber component from the viewpoint of exhibiting the effect of the addition of the silica-based inorganic filler, and is preferably 150 parts by mass or less based on 100 parts by mass of the rubber component from the viewpoint of sufficiently dispersing the silica-based inorganic filler to attain practically sufficient processability and mechanical strength of the rubber composition.

Examples of the carbon black used as the filler include, but are not limited to, carbon blacks of SRF, FEF, HAF, ISAF and SAF classes. Among these, a carbon black having a nitrogen adsorption specific surface area of 50 m²/g or more and dibutyl phthalate (DBP) oil absorption of 80 mL/100 g or less is preferred.

A content of the carbon black in the rubber composition of the present embodiment is preferably 0.5 parts by mass or more and 100 parts by mass or less, more preferably 3.0 parts by mass or more and 100 parts by mass or less, and further preferably 5.0 parts by mass or more and 50 parts by mass or less based on 100 parts by mass of the rubber component containing the copolymer of the present embodiment. From the viewpoint of exhibiting performances required in use as a tire or the like such as dry grip performance and conductivity, the content of the carbon black in the rubber composition of the present embodiment is preferably 0.5 parts by mass or more, and from the viewpoint of dispersibility, the content is preferably 100 parts by mass or less based on 100 parts by mass of the rubber component.

The metal oxide used as the filler refers to a solid particle containing a principal component of a constituent unit represented by chemical formula MₓO_{y} (wherein M represents a metal atom, and x and y each independently represent an integer of 1 to 6).

Examples of the metal oxide include, but are not limited to, alumina, titanium oxide, magnesium oxide and zinc oxide.

Examples of the metal hydroxide used as the filler include, but are not limited to, aluminum hydroxide, magnesium hydroxide and zirconium hydroxide.

The rubber composition of the present embodiment may contain a silane coupling agent. The silane coupling agent is preferably a compound that has a function to make close the interaction between the rubber component and the silica-based inorganic filler in the rubber composition, has a group having affinity with or a binding property to both of the rubber component and the silica-based inorganic filler, and contains, in one molecule, a sulfur bond portion and an alkoxysilyl group or silanol group portion.

Examples of such a compound include, but are not limited to, bis-[3-(triethoxysilyl)-propyl]-tetrasulfide, bis-[3-(triethoxysilyl)-propyl]-disulfide and bis-[2-(triethoxysilyl)-ethyl]-tetrasulfide.

A content of the silane coupling agent in the rubber composition of the present embodiment is preferably 0.1 parts by mass or more and 30 parts by mass or less, more preferably 0.5 parts by mass or more and 20 parts by mass or less, and further preferably 1.0 part by mass or more and 15 parts by mass or less based on 100 parts by mass of the silica-based inorganic filler. If the content of the silane coupling agent falls in the aforementioned range, there is a tendency that the effect of the addition of the silane coupling agent can be more conspicuous.

The rubber composition of the present embodiment may contain a rubber softener from the viewpoint of improvement of the processability.

An amount of the rubber softener to be added in the rubber composition is expressed as a total amount, based on 100 parts by mass of the rubber component containing the copolymer of the present embodiment, of the amount of a rubber softener precedently contained in the copolymer or another copolymer and the amount of a rubber softener to be added in obtaining a rubber composition.

As the rubber softener to be used in the rubber composition, an extender oil, a liquid rubber and a resin are preferable.

A mineral oil-based rubber softener, which is used for softening, expanding and improving processability of a rubber and is designated as a process oil or an extender oil, is a mixture of an aromatic ring, a naphthene ring and a paraffin chain, and one in which the number of carbon atoms of the paraffin chain is 50% or more of the number of all carbon atoms is designated as a paraffin-based softener, one in which the number of carbon atoms of the naphthene ring is 30% or more and 45% or less of the number of all carbon atoms is designated as a naphthene-based softener, and one in which the number of aromatic carbon atoms exceeds 30% of the number of all carbon atoms is designated as an aromatic-based softener. When the copolymer of the present embodiment is a copolymer of a conjugated diene compound and an aromatic vinyl compound, a rubber softener to be used is preferably one having an appropriate aromatic content because such a softener tends to fit with the copolymer.

A content of the rubber softener in the rubber composition of the present embodiment is preferably 0 part by mass or more and 100 parts by mass or less, more preferably 10 parts by mass or more and 90 parts by mass or less, and further preferably 30 parts by mass or more and 90 parts by mass or less based on 100 parts by mass of the rubber component containing the copolymer or the copolymer composition of the present embodiment. If the content of the rubber softener in the rubber composition is 100 parts by mass or less based on 100 parts by mass of the rubber component, there is a tendency that the bleeding out can be suppressed and the stickiness of the surface of the rubber composition of the present embodiment can be suppressed.

(Method for Producing Rubber Composition)

The rubber composition of the present embodiment can be obtained by mixing the rubber component containing the copolymer or the copolymer composition of the present embodiment, the silica-based inorganic filler, carbon black and another filler, and various additives such as the silane coupling agent and the rubber softener if necessary.

Specific examples of a mixing method include, but are not limited to, a melt-kneading method using a general mixer such as an open roll, a Banbury mixer, a kneader, a single shaft screw extruder, a twin shaft screw extruder or a multi-shaft screw extruder, and a method in which the respective components are melted and mixed followed by removal of a solvent by heating.

Among these methods, the melt-kneading method using a roll, a banbury mixer, a kneader or an extruder is preferred from the viewpoint of productivity and high kneadability. Besides, either of a method in which the rubber component, the filler, the silane coupling agent and the various additives are kneaded all together or a method in which these are mixed dividedly in plural times is applicable.

(Vulcanizate)

The rubber composition of the present embodiment may be in the form of a vulcanizate obtained by a vulcanization treatment with a vulcanizing agent.

Examples of the vulcanizing agent include, but are not limited to, radical generators such as organic peroxides and azo compounds, oxime compounds, nitroso compounds, polyamine compounds, sulfur and sulfur compounds.

The sulfur compounds include sulfur monochloride, sulfur dichloride, disulfide compounds and high molecular weight polysulfide compounds.

A content of the vulcanizing agent in the rubber composition of the present embodiment is preferably 0.01 parts by mass or more and 20 parts by mass or less, and more preferably 0.1 parts by mass or more and 15 parts by mass or less based on 100 parts by mass of the rubber component. As a vulcanizing method, any of known methods is applicable, and a vulcanization temperature is preferably 120° C. or more and 200° C. or less, and more preferably 140° C. or more and 180° C. or less.

For the vulcanization, a vulcanization accelerator may be used if necessary.

As the vulcanization accelerator, any of known materials can be used, and examples include, but are not limited to, sulphenamide-based, guanidine-based, thiuram-based, aldehyde-amine-based, aldehyde-ammonia-based, thiazole-based, thiourea-based and dithiocarbamate-based vulcanization accelerators. Besides, examples of a vulcanization aid include, but are not limited to, zinc oxide and stearic acid. A content of the vulcanization accelerator is preferably 0.01 parts by mass or more and 20 parts by mass or less, and more preferably 0.1 parts by mass or more and 15 parts by mass or less based on 100 parts by mass of the rubber component.

(Other Additives)

The rubber composition of the present embodiment may contain, as long as the object of the present embodiment is not impaired, various additives such as another softener excluding those described above, a filler, a heat resistance stabilizer, an antistatic agent, a weathering stabilizer, an anti-ageing agent, a colorant and a lubricant.

As another softener, any of known softeners can be used.

Examples of another filler include calcium carbonate, magnesium carbonate, aluminum sulfate and barium sulfate.

As each of the heat resistance stabilizer, the antistatic agent, the weathering stabilizer, the anti-ageing agent, the colorant and the lubricant, any of known materials can be used.

[Tire]

The rubber composition of the present embodiment is suitably applicable to a tire.

Examples of application to a tire include, but are not limited to, applications to various tires such as a fuel-efficient tire, an all-season tire, a high-performance tire and a studless tire; and various tire portions such as a tread, a carcass, a sidewall and a bead.

In particular, since the rubber composition of the present embodiment is excellent in abrasion resistance, fracture strength and balance between a low hysteresis loss property and wet grip performance obtained in the form of a vulcanizate, it is suitably applied as a material of a tread of a fuel-efficient tire or a high-performance tire.

### EXAMPLES

The present embodiment will now be described in more detail with reference to specific examples and comparative examples, and it is noted that the present invention is not limited to the following examples and comparative examples at all.

Various physical properties of the examples and comparative examples were measured by the following methods.

[Methods for Measuring Physical Properties]

(Weight Average Molecular Weight)

Measurement conditions: A copolymer was used as a sample for measuring a chromatogram using a GPC measurement apparatus (trade name “HLC-8320GPC” manufactured by Tosoh Corporation) including a series of three columns using a polystyrene-based gel as a filler with an RI detector (trade name “HLC8020” manufactured by Tosoh Corporation) used, and on the basis of a calibration curve obtained using standard polystyrene, a weight average molecular weight (Mw) of the sample was obtained.

As an eluent, THE (tetrahydrofuran) containing 5 mmol/L of triethylamine was used.

As the columns, a guard column of trade name “TSKguardcolumn Super H-H” manufactured by Tosoh Corporation, and columns of trade names “TSKgel SuperH5000”, “TSKgel SuperH6000”, and “TSKgel SuperH7000” manufactured by Tosoh Corporation were used.

An RI detector (trade name “HLC8020” manufactured by Tosoh Corporation) was used under conditions of an oven temperature of 40° C. and a THE flow rate of 0.6 mL/min. Ten (10) mg of a sample for the measurement was dissolved in 20 mL of THE to obtain a measurement solution, and 20 L of the measurement solution was injected into the GPC measurement apparatus for performing the measurement.

(Modification Ratio)

A copolymer not containing a rubber softener was used as a sample, or as for a copolymer composition containing a rubber softener, the copolymer from which the rubber softener had been removed was used as a sample, and a modification ratio of the copolymer was measured by column adsorption GPC as follows:

The modification ratio was measured by applying a characteristic that a modified basic polymer component adsorbs onto a GPC column using a silica-based gel as a filler.

The modification ratio of the copolymer was obtained by measuring an amount of adsorption onto a silica-based column based on a difference between a chromatogram measured by using a polystyrene-based column and a chromatogram measured by using a silica-based column both obtained from a sample solution containing the sample and low molecular weight internal standard polystyrene.

<Preparation of Sample Solution>

Ten (10) mg of a sample and 5 mg of standard polystyrene were dissolved in 20 mL of THE to obtain a sample solution.

<GPC Measurement Conditions Using Polystyrene-Based Column>

An apparatus of trade name “HLC-8320GPC” manufactured by Tosoh Corporation was used, THE containing 5 mmol/L of triethylamine was used as an eluent, and 10 μL of the sample solution was injected into the apparatus to obtain a chromatogram using an RI detector under conditions of a column oven temperature of 40° C. and a THE flow rate of 0.35 mL/min. As the columns, trade name “TSKguardcolumn Super MP(HZ)-H” manufactured by Tosoh Corporation connected, as a guard column at a previous stage, to a series of three columns of trade name “TSKgel Super Multipore HZ-H” manufactured by Tosoh Corporation were used.

<GPC Measurement Conditions Using Silica-Based Column>

An apparatus of trade name “HLC-8320GPC” manufactured by Tosoh Corporation was used, THE was used as an eluent, and 50 μL of the sample solution was injected into the apparatus to obtain a chromatogram by using an RI detector under conditions of a column oven temperature of 40° C. and a THE flow rate of 0.5 ml/min. A series of columns of trade names “Zorbax PSM-1000S”, “PSM-300S” and “PSM-60S”, and a guard column of trade name “DIOL 4.6×12.5 mm 5 micron” connected at a previous stage were used.

<Calculation Method for Modification Ratio of Copolymer>

It was assumed that the whole peak area of the chromatogram obtained by using the polystyrene-based column was 100, that a peak area of the sample was P1, and that a peak area of standard polystyrene was P2. It was also assumed that the whole peak area of the chromatogram obtained by using the silica-based column was 100, that a peak area of the sample was P3, and that a peak area of standard polystyrene was P4. The modification ratio (%) of the copolymer was obtained based on the peak areas P1 to P4 in accordance with the following expression:

Modification ratio (%)=[1−(P2×P3)/(P1×P4)]×100

wherein P1+P2=P3+P4=100.

(Amount of Bound Styrene, and Contents C1 to C4 of Structures Represented by Formulas (1) to (4))

A copolymer was used as a sample to measure, using a nuclear magnetic resonance apparatus (¹H-NMR), an amount of bound styrene in the copolymer, the content C1 of the structure represented by the formula (1), the content C2 of the structure represented by the formula (2), the content C3 of the structure represented by the formula (3), and the content C4 of the structure represented by the formula (4) under the following conditions. The conditions for ¹H-NMR measurement were as follows.

<Measurement Conditions>

Measurement apparatus: JNM-LA400 (manufactured by JEOL Ltd.)

Solvent: deuterated chloroform

Measurement sample: copolymer

Sample concentration: 50 mg/mL

Observation frequency: 400 MHz

Chemical shift standard: TMS (tetramethylsilane)

Pulse delay: 2.904 sec

Number of times of scanning: 64

Pulse width: 450

Measurement temperature: 26° C.

(Amount of Block Styrene)

Assuming that a chain containing 8 or more styrene structural units is designated as block styrene, an amount of block styrene was obtained as follows.

Based on a ¹H-NMR spectrum measured at 400 MHz with deuterated chloroform used as a solvent, a ratio of an integrated value of the following (X) in each chemical shift range was obtained, and thus, the amount of the block styrene contained in the copolymer was obtained.

(X) Chain of eight or more aromatic vinyl compounds: 6.00≤X<6.68

(Content of Cis Bond and Content of Trans Bond)

A copolymer was used as a sample to measure contents of a cis bond and a trans bond in the structure represented by the formula (3) in the copolymer with a nuclear magnetic resonance apparatus (¹³C-NMR).

Measurement conditions were the same as the above-described measurement conditions for the ¹H-NMR except that the number of times of scanning was changed to 256.

(Silicon Content)

A silicon content in the copolymer was obtained with an ICP emission spectroscope (ICPS-8100, manufactured by Shimadzu Corporation).

[Production of Copolymer]

(Preparation of Hydrogenation Catalyst)

A hydrogenation catalyst to be used in producing a copolymer in each of examples and comparative examples described below was prepared as follows:

A nitrogen-substituted reaction vessel equipped with a stirrer was charged with 1 L of dried and purified cyclohexane.

To the resultant, 100 mmol of bis(115-cyclopentadienyl)titanium dichloride was added. A n-hexane solution containing 200 mmol of trimethylaluminum was added thereto under sufficient stirring, and the resultant was reacted at room temperature for about 3 days. Thus, a hydrogenation catalyst (T) was obtained.

### (Comparative Example 1) Copolymer 1

A temperature-controllable autoclave having an internal capacity of 40 L and equipped with a stirrer and a jacket was used as a reactor, and was charged with 1,000 g of 1,3-butadiene, 300 g of styrene, and 21,000 g of cyclohexane, from which impurities had been precedently removed, and 43.1 mmol of tetrahydrofuran (THF) used as a polar compound, and the temperature within the reactor was kept at 70° C.

As a polymerization initiator, 43.1 mmol of n-butyllithium was supplied to the reactor.

After starting a polymerization reaction, the temperature within the reactor started to increase due to heat generation through polymerization, and after monomer conversion within the reactor reached 90%, 300 g of styrene was continuously added thereto over 15 minutes, and at the same time, 1,400 g of 1,3-butadiene was continuously added thereto over 40 minutes to cause a reaction.

The temperature within the reactor finally reached 83° C., and an average temperature within the reactor was 79° C. Two minutes after reaching this temperature peak within the reactor, 8.6 mmol of silicon tetrachloride (compound 1) was added to the reactor to perform a coupling reaction for 20 minutes. To the thus obtained polymer solution, 8.6 mmol of methanol used as a reaction terminator was added to obtain a copolymer solution.

A part of the thus obtained copolymer solution before hydrogenation was extracted, and was desolvated with a dryer to obtain a copolymer.

To the copolymer solution, 12.6 g of n-octadecyl-3-(3,5-di-t-butyl-4-hydroxyphenyl)-propionate (antioxidant 1) and 3.0 g of 4,6-bis(octylthiomethyl)-o-cresol (antioxidant 2) were added, and the resultant was subjected to a desolvating and drying treatment to obtain a copolymer 1.

Polymerization conditions for the copolymer 1 are shown in Table 1. It is noted that the copolymer is shown as “Polymer 1” in the table.

The copolymer 1 was analyzed by the above-described methods. Analysis results thus obtained are shown in Table 3.

### (Comparative Examples 2 and 4) Copolymers 2 and 7

Respective copolymers (a copolymer 2 and a copolymer 7) were obtained in the same manner as in Comparative Example 1 except that the polymerization prescription was changed as shown in Table 1. As the coupling agent, 2,2-dimethoxy-1-(3-trimethoxysilylpropyl)-1-aza-2-silacyclopentane (compound 2) was used.

It is noted that these copolymers are shown as

“Polymer 2” and “Polymer 7” in the table. The copolymers 2 and 7 were analyzed by the above-described methods. Analysis results thus obtained are shown in Table 3.

### (Example 1) Copolymer 3

A temperature-controllable autoclave having an internal capacity of 40 L and equipped with a stirrer and a jacket was used as a reactor, and was charged with 1,000 g of 1,3-butadiene, 300 g of styrene, and 21,000 g of cyclohexane, from which impurities had been precedently removed, and 43.1 mmol of tetrahydrofuran (THF) used as a polar compound, and the temperature within the reactor was kept at 70° C.

As a polymerization initiator, 43.1 mmol of n-butyllithium was supplied to the reactor.

After starting a polymerization reaction, the temperature within the reactor started to increase due to heat generation through polymerization, and after monomer conversion within the reactor reached 80%, 300 g of styrene was continuously added thereto over 15 minutes, and at the same time, 1,400 g of 1,3-butadiene was continuously added thereto over 40 minutes to cause a reaction.

The temperature within the reactor finally reached 83° C., and an average temperature within the reactor was 79° C. Two minutes after reaching this temperature peak within the reactor, 8.6 mmol of 2,2-dimethoxy-1-(3-trimethoxysilylpropyl)-1-aza-2-silacyclopentane (compound 2) was added to the reactor to perform a coupling reaction for 20 minutes. To the thus obtained polymer solution, 8.6 mmol of methanol used as a reaction terminator was added to obtain a copolymer solution before hydrogenation.

A part of the thus obtained copolymer solution before hydrogenation was extracted, and was desolvated with a dryer to obtain a copolymer before hydrogenation.

To the copolymer solution, the hydrogenation catalyst (T) was added in an amount, in terms of titanium, of 50 ppm per 100 parts by mass of the copolymer, and a hydrogenation reaction was performed at a hydrogen pressure of 0.85 MPa and an average temperature of 90° C. until a prescribed amount of hydrogen had been reacted. Thereafter, 12.6 g of n-octadecyl-3-(3,5-di-t-butyl-4-hydroxyphenyl)-propionate (antioxidant 1) and 3.0 g of 4,6-bis(octylthiomethyl)-o-cresol (antioxidant 2) were added thereto, and the resultant was subjected to a desolvating and drying treatment to obtain a copolymer 3. It is noted that the copolymer is shown as “Polymer 3” in the table.

Polymerization conditions for the copolymer 3 are shown in Table 1.

The copolymer 3 was analyzed by the above-described methods. Analysis results thus obtained are shown in Table 3.

### (Examples 2 to 9, and Comparative Examples 3 and 5 to 7) Copolymers 4 to 6 and 8 to 16

Respective copolymers (copolymers 4 to 6 and 8 to 16) were obtained in the same manner as in Example 1 except that the polymerization prescription was changed as shown in Tables 1 and 2.

In Example 7, as the coupling agent, 1,3-dimethyl-2-imidazolidinone (compound 3) was used.

It is noted that these copolymers are shown as “Polymers 4 to 6 and 8 to 16” in the tables.

The copolymers 4 to 6 and 8 to 16 were analyzed by the above-described methods. Analysis results thus obtained are shown in Tables 3 and 4.

### (Comparative Example 8) Copolymer 17

A temperature-controllable autoclave having an internal capacity of 40 L and equipped with a stirrer and a jacket was used as a reactor, and was charged with 1,000 g of 1,3-butadiene, 300 g of styrene, and 21,000 g of cyclohexane, from which impurities had been precedently removed, and 77.8 mmol of tetrahydrofuran (THF) and 7.8 mmol of 2,2-bis(2-oxolanyl)propane (BOP) used as polar compounds, and the temperature within the reactor was kept at 46° C.

As a polymerization initiator, 38.9 mmol of n-butyllithium was supplied to the reactor.

After starting a polymerization reaction, the temperature within the reactor started to increase due to heat generation through polymerization, and after monomer conversion within the reactor reached 80%, 300 g of styrene was continuously added thereto over 15 minutes, and at the same time, 1,400 g of 1,3-butadiene was continuously added thereto over 15 minutes to cause a reaction. The temperature within the reactor finally reached 86° C., and an average temperature within the reactor was 81° C.

Two minutes after reaching this temperature peak within the reactor, 7.8 mmol of 2,2-dimethoxy-1-(3-trimethoxysilylpropyl)-1-aza-2-silacyclopentane (compound 2) was added to the reactor to perform a coupling reaction for 20 minutes. To the thus obtained polymer solution, 7.8 mmol of methanol used as a reaction terminator was added to obtain a copolymer solution before hydrogenation.

A part of the thus obtained copolymer solution before hydrogenation was extracted, and was desolvated with a dryer to obtain a copolymer before hydrogenation.

To the copolymer solution, the hydrogenation catalyst (T) was added in an amount, in terms of titanium, of 50 ppm per 100 parts by mass of the copolymer, and a hydrogenation reaction was performed at a hydrogen pressure of 0.85 MPa and an average temperature of 90° C. until a prescribed amount of hydrogen had been reacted. Thereafter, 12.6 g of n-octadecyl-3-(3,5-di-t-butyl-4-hydroxyphenyl)-propionate (antioxidant 1) and 3.0 g of 4,6-bis(octylthiomethyl)-o-cresol (antioxidant 2) were added thereto, and the resultant was subjected to a desolvating and drying treatment to obtain a copolymer 17.

It is noted that the copolymer is shown as “Polymer 17” in the table.

Polymerization conditions for the copolymer 17 are shown in Table 2.

The copolymer 17 was analyzed by the above-described methods. Analysis results thus obtained are shown in Table 4.

The compounds 1 to 3 shown as the coupling agent in Tables 1 and 2 are as follows:

Compound 1: silicon tetrachloride

Compound 2: 2,2-dimethoxy-1-(3-trimethoxysilylpropyl)-1-aza-2-silacyclopentane

Compound 3: 1,3-dimethyl-2-imidazolidinone

TABLE 1

| | | Comparative | Comparative | | | | Comparative | Comparative | Comparative |
|---|---|---|---|---|---|---|---|---|---|
| | | Example 1 | Example 2 | Example 1 | Example 2 | Example 3 | Example 3 | Example 4 | Example 5 |
| | | Polymer 1 | Polymer 2 | Polymer 3 | Polymer 4 | Polymer 5 | Polymer 6 | Polymer 7 | Polymer 8 |
| Initial Styrene | g | 300 | 300 | 300 | 300 | 300 | 300 | 700 | 700 |
| Additional Styrene | g | 300 | 300 | 300 | 300 | 300 | 300 | 500 | 500 |
| Addition Time | min | 15 | 15 | 15 | 15 | 15 | 15 | 20 | 20 |
| Initial Butadiene | g | 1000 | 1000 | 1000 | 1000 | 1000 | 1000 | 900 | 900 |
| Additional Butadiene | g | 1400 | 1400 | 1400 | 1400 | 1400 | 1400 | 900 | 900 |
| Addition Time | min | 40 | 40 | 40 | 40 | 40 | 40 | 30 | 30 |
| Cyclohexane | g | 21000 | 21000 | 21000 | 21000 | 21000 | 21000 | 21000 | 21000 |
| n-Butyllithium | mmol | 43.1 | 43.1 | 43.1 | 43.1 | 43.1 | 43.1 | 31.9 | 31.9 |
| THF | mmol | 43.1 | 43.1 | 43.1 | 43.1 | 43.1 | 43.1 | 15.9 | 15.9 |
| BOP | mmol | 0 | 0 | 0 | 0 | 0 | 0 | 0 | 0 |
| Polymerization Starting | ° C. | 70 | 70 | 70 | 70 | 70 | 70 | 73 | 73 |
| Temperature | | | | | | | | | |
| Type of Coupling Agent | | Compound 1 | Compound 2 | Compound 2 | Compound 2 | Compound 2 | Compound 2 | Compound 2 | Compound 2 |
| Amount of Coupling Agent | mmol | 8.6 | 8.6 | 8.6 | 8.6 | 8.6 | 8.6 | 3.8 | 3.8 |
| Added | | | | | | | | | |
| Methanol | mmol | 8.6 | 8.6 | 8.6 | 8.6 | 8.6 | 8.6 | 16.6 | 16.6 |
| Hydrogenation Catalyst | | — | — | TCLi | TCLi | TCLi | TCLi | — | TCLi |
| Amount of Hydrogenation | | 0 | 0 | 50 | 50 | 50 | 70 | 0 | 50 |
| Catalyst Added | | | | | | | | | |

TABLE 2

| | | | | | Comparative | | | | Comparative | Comparative |
|---|---|---|---|---|---|---|---|---|---|---|
| | | Example 4 | Example 5 | Example 6 | Example 6 | Example 7 | Example 8 | Example 9 | Example 7 | Example 8 |
| | | Polymer 9 | Polymer 10 | Polymer 11 | Polymer 12 | Polymer 13 | Polymer 14 | Polymer 15 | Polymer 16 | Polymer 17 |
| Initial Styrene | g | 700 | 700 | 700 | 700 | 700 | 700 | 700 | 0 | 300 |
| Additional | g | 500 | 500 | 500 | 500 | 500 | 500 | 500 | 0 | 300 |
| Styrene | | | | | | | | | | |
| Addition Time | min | 20 | 20 | 20 | 20 | 20 | 30 | 30 | 0 | 5 |
| Initial | g | 900 | 900 | 900 | 900 | 900 | 900 | 900 | 1500 | 1000 |
| Butadiene | | | | | | | | | | |
| Additional | g | 900 | 900 | 900 | 900 | 900 | 900 | 900 | 1500 | 1400 |
| Butadiene | | | | | | | | | | |
| Addition Time | min | 30 | 30 | 30 | 30 | 30 | 50 | 50 | 20 | 15 |
| Cyclohexane | g | 21000 | 21000 | 21000 | 21000 | 21000 | 21000 | 21000 | 21000 | 21000 |
| n-Butyllithium | mmol | 31.9 | 31.9 | 31.9 | 31.9 | 15.9 | 70.0 | 20.6 | 32.8 | 38.9 |
| THF | mmol | 15.9 | 15.9 | 15.9 | 15.9 | 8.0 | 27.0 | 13.3 | 16.4 | 77.8 |
| BOP | mmol | 0 | 0 | 0 | 0 | 0 | 0 | 0 | 0 | 7.8 |
| Polymerization | ° C. | 73 | 73 | 73 | 73 | 75 | 71 | 76 | 66 | 46 |
| Starting | | | | | | | | | | |
| Temperature | | | | | | | | | | |
| Type of | | Compound | Compound | Compound | Compound | Compound | Compound | Compound | Compound | Compound |
| Coupling | | 2 | 2 | 2 | 2 | 3 | 2 | 1 | 2 | 2 |
| Agent | | | | | | | | | | |
| Amount of | mmol | 3.8 | 3.8 | 3.8 | 3.8 | 11.3 | 10.5 | 2.5 | 3.9 | 4.7 |
| Coupling | | | | | | | | | | |
| Agent Added | | | | | | | | | | |
| Methanol | mmol | 16.6 | 16.6 | 16.6 | 16.6 | 5.9 | 26.5 | 10.3 | 17.0 | 20.2 |
| Hydrogenation | | TCLi | TCLi | TCLi | TCLi | TCLi | TCLi | TCLi | TCLi | TCLi |
| Catalyst | | | | | | | | | | |
| Amount of | | 50 | 50 | 50 | 70 | 50 | 50 | 50 | 40 | 50 |
| Hydrogenation | | | | | | | | | | |
| Catalyst Added | | | | | | | | | | |

TABLE 3

| | | Comparative | Comparative | | | | Comparative | Comparative | Comparative |
|---|---|---|---|---|---|---|---|---|---|
| | | Example 1 | Example 2 | Example 1 | Example 2 | Example 3 | Example 3 | Example 4 | Example 5 |
| | | Polymer 1 | Polymer 2 | Polymer 3 | Polymer 4 | Polymer 5 | Polymer 6 | Polymer 7 | Polymer 8 |
| Amount of Bound Styrene | mass % | 20 | 20 | 20 | 20 | 20 | 20 | 40 | 40 |
| C1 | mass % | 15.0 | 15.0 | 0.4 | 0.3 | 0.1 | 0.0 | 8.0 | 3.8 |
| C2 | mass % | 0.0 | 0.0 | 16.6 | 15.0 | 15.0 | 15.0 | 0.0 | 4.4 |
| C3 | mass % | 85.0 | 85.0 | 59.1 | 47.1 | 19.4 | 1.2 | 92.0 | 88.0 |
| C4 | mass % | 0.0 | 0.0 | 23.8 | 37.6 | 65.5 | 83.8 | 0.0 | 4.1 |
| C1 + C2 | mass % | 15.0 | 15.0 | 17.0 | 15.3 | 15.1 | 15.0 | 8.0 | 8.2 |
| C2 + C4 | mass % | 0.00 | 0.00 | 40.4 | 52.6 | 80.5 | 98.8 | 0.0 | 8.5 |
| Cis Bond in C3 | mass % | 33.0 | 33.0 | 29.8 | 13.7 | 3.9 | 0.2 | 35.8 | 33.6 |
| Trans Bond in C3 | mass % | 52.0 | 52.0 | 47.6 | 33.4 | 15.5 | 1.0 | 56.2 | 54.4 |
| Trans Bond-Cis Bond in C3 | mass % | 19.0 | 19.0 | 17.9 | 19.6 | 11.7 | 0.8 | 20.4 | 20.8 |
| Amount of Block Styrene | mass % | 1.1 | 1.1 | 1.1 | 1.1 | 1.1 | 1.1 | 2.9 | 2.9 |
| Weight Average Molecular | ten | 25.0 | 25.0 | 25.0 | 25.0 | 25.0 | 25.0 | 22.0 | 22.0 |
| Weight | thousand | | | | | | | | |
| Modification Ratio | % | 0.0 | 80.0 | 80.0 | 80.0 | 80.0 | 80.0 | 48.0 | 48.0 |
| Silicon Content | ppm | 80.7 | 80.7 | 80.7 | 80.7 | 80.7 | 80.7 | 35.8 | 35.8 |

TABLE 4

| | | | | | Comparative | | | | Comparative | Comparative |
|---|---|---|---|---|---|---|---|---|---|---|
| | | Example 4 | Example 5 | Example 6 | Example 6 | Example 7 | Example 8 | Example 9 | Example 7 | Example 8 |
| | | Polymer 9 | Polymer 10 | Polymer 11 | Polymer 12 | Polymer 13 | Polymer 14 | Polymer 15 | Polymer 16 | Polymer 17 |
| Amount of | mass % | 40 | 40 | 40 | 40 | 40 | 40 | 40 | 0 | 20 |
| Bound | | | | | | | | | | |
| Styrene | | | | | | | | | | |
| C1 | mass % | 1.8 | 0.5 | 0.2 | 0.0 | 0.5 | 0.5 | 0.5 | 1.0 | 1.9 |
| C2 | mass % | 6.4 | 7.7 | 7.9 | 8.0 | 7.7 | 7.7 | 7.7 | 14.3 | 38.7 |
| C3 | mass % | 71.3 | 59.1 | 38.1 | 2.8 | 59.1 | 59.1 | 59.1 | 48.1 | 38.3 |
| C4 | mass % | 20.5 | 32.7 | 53.8 | 89.2 | 32.7 | 32.7 | 32.7 | 36.7 | 21.4 |
| C1 + C2 | mass % | 8.2 | 8.2 | 8.1 | 8.0 | 8.2 | 8.2 | 8.2 | 15.2 | 40.6 |
| C2 + C4 | mass % | 26.9 | 40.4 | 61.7 | 97.2 | 40.4 | 40.4 | 40.4 | 50.9 | 60.1 |
| Cis Bond | mass % | 28.8 | 17.7 | 8.8 | 0.8 | 17.7 | 17.7 | 17.7 | 14.7 | 11.8 |
| in C3 | | | | | | | | | | |
| Trans Bond | mass % | 48.6 | 41.4 | 29.3 | 2.0 | 41.4 | 41.4 | 41.4 | 33.4 | 17.7 |
| in C3 | | | | | | | | | | |
| Trans Bond- | mass % | 19.9 | 23.7 | 20.5 | 1.3 | 23.7 | 23.7 | 23.7 | 18.7 | 5.9 |
| Cis | | | | | | | | | | |
| Bond in C3 | | | | | | | | | | |
| Amount of | mass % | 2.9 | 2.9 | 2.9 | 2.9 | 3.0 | 2.3 | 3.3 | 0.0 | 1.1 |
| Block | | | | | | | | | | |
| Styrene | | | | | | | | | | |
| Weight | ten | 22.0 | 22.0 | 22.0 | 22.0 | 26.0 | 9.7 | 33.0 | 22.0 | 22.0 |
| Average | thou- | | | | | | | | | |
| Molecular | sand % | | | | | | | | | |
| Weight | | | | | | | | | | |
| Modification | | 48.0 | 48.0 | 48.0 | 48.0 | 65.0 | 60.0 | 0.0 | 48.0 | 48.0 |
| Ratio | | | | | | | | | | |
| Silicon | ppm | 35.8 | 35.8 | 35.8 | 35.8 | 0.0 | 98.2 | 23.6 | 36.9 | 43.7 |
| Content | | | | | | | | | | |

### [Examples 10 to 18] and [Comparative Examples 9 to 16]

(Production of Rubber Composition)

The polymers 1 to 17 shown in Tables 3 and 4 were respectively used as raw material rubbers to obtain rubber compositions respectively containing raw material rubber components in accordance with the following blending conditions:

(Rubber Component)
Copolymer (any one of the copolymers 1 to 17): 100 parts by mass

(Conditions for Components to be Blended)

An amount of each component to be blended is indicated in parts by mass based on 100 parts by mass of a rubber component excluding a rubber softener.
Silica 1 (trade name “Ultrasil 7000GR”, manufactured by Evonik Degussa, nitrogen adsorption specific surface area: 170 m²/g): 50.0 parts by mass
Silica 2 (trade name “Zeosil Premium 200MP” manufactured by Rhodia, nitrogen adsorption specific surface area: 220 m²/g): 25.0 parts by mass
Carbon black (trade name “Seast KH (N339)”, manufactured by Tokai Carbon Co., Ltd.): 5.0 parts by mass
Silane coupling agent: (trade name “Si75”, manufactured by Evonik Degussa, bis(triethoxysilylpropyl)disulfide): 6.0 parts by mass
SRAE oil (trade name “Process NC140”, manufactured by JX Nippon Oil & Energy Corporation): 25.0 parts by mass
Zinc oxide: 2.5 parts by mass
Stearic acid: 1.0 part by mass
Anti-ageing agent (N-(1,3-dimethylbutyl)-N′-phenyl-p-phenylenediamine): 2.0 parts by mass
Sulfur: 2.2 parts by mass
Vulcanization accelerator 1 (N-cyclohexyl-2-benzothiazylsulfinamide): 1.7 parts by mass
Vulcanization accelerator 2 (diphenylguanidine): 2.0 parts by mass
Total: 222.4 parts by mass

(Kneading Method)

The above-described materials were kneaded by the following method to obtain a rubber composition.

A closed kneader (having an internal volume of 0.3 L) equipped with a temperature controller was used to knead, as a first stage of kneading, the raw material rubber component (each of the copolymers 1 to 17), the fillers (silica 1, silica 2 and carbon black), the silane coupling agent, SRAE oil, zinc oxide and stearic acid under conditions of a filling ratio of 65% and a rotor rotation speed of 30 to 50 rpm. Here, the temperature of the closed kneader was controlled to obtain each rubber composition (compound) at a discharging temperature of 155 to 160° C.

Next, after cooling the compound obtained as described above to room temperature, as a second stage of the kneading, the anti-ageing agent was added thereto, and the resultant was kneaded again to improve dispersibility of the silica. Also in this case, the temperature of the closed kneader was controlled to adjust the discharging temperature of the compound to 155 to 160° C.

After cooling, as a third stage of the kneading, sulfur and the vulcanization accelerators 1 and 2 were added, and the resultant was kneaded with an open roll set to 70° C. to obtain a rubber composition.

Thereafter, the thus obtained rubber composition was molded and vulcanized at 160° C. for 20 minutes with a vulcanizing press. The rubber compositions prior to the vulcanization, and the rubber compositions after the vulcanization were evaluated. Specifically, the evaluations were performed as described below.

(Processability: Mooney Viscosity of Compound)

Each compound obtained after the second stage of the kneading and before the third stage of the kneading was used as a sample to measure a viscosity by using a Mooney viscometer in accordance with ISO 289 after preheating the compound at 130° C. for 1 minute, and after rotating a rotor for 4 minutes at 2 rpm.

The thus obtained result of each of Comparative Examples 10 to 16 and Examples 10 to 18 was shown as an index obtained assuming that the result of Comparative Example 9 was 100. A larger index indicates a lower Mooney viscosity of the compound and better processability.

A copolymer having an index of 110 or more was evaluated as very good, a copolymer having an index of 95 or more and less than 110 was evaluated as good, a copolymer having an index of 85 or more and less than 95 was evaluated as having no practical problem, and a copolymer having an index less than 85 was evaluated as having a practical problem.

(Break Strength, Elongation at Break, and Fracture Performance)

Tensile strength and tensile elongation were measured in accordance with a tensile test method according to JIS K6251 to evaluate breaking strength and elongation at break. Besides, fracture performance was defined as a product of the measured values of tensile strength and tensile elongation.

The thus obtained result of each of Comparative Examples 10 to 16 and Examples 10 to 18 was shown as an index obtained assuming that the result of Comparative Example 9 was 100. A larger index indicates better breaking strength and elongation at break.

A copolymer having an index of 120 or more was evaluated as very good, a copolymer having an index of 105 or more and less than 120 was evaluated as good, and a copolymer having an index of less than 105 was evaluated as equivalent or inferior to that obtained by existing technique.

(Low Fuel Consumption Performance and Wet Grip Performance)

A viscoelasticity testing machine “ARES” manufactured by Rheometric Scientific, Inc. was used to measure, in a torsion mode, a viscoelasticity parameter of each rubber composition after vulcanization.

A tan δ measured at 50° C. at a frequency of 10 Hz and strain of 3% was used as an index of low fuel consumption performance. A larger index indicates better low fuel consumption performance.

Besides, a tan δ measured at 0° C. at a frequency of 10 Hz and strain of 1% was used as an index of wet grip performance. A larger index indicates better wet grip performance.

With respect to both low fuel consumption performance and wet grip performance, the result of each of Comparative Examples 10 to 16 and Examples 10 to 18 was shown as an index obtained assuming that the result of Comparative Example 9 was 100. A larger index indicates better low fuel consumption performance and better wet grip performance.

With respect to low fuel consumption performance, a copolymer having an index of 140 or more was evaluated as very good, a copolymer having an index of 120 or more and less than 140 was evaluated as good, and a copolymer having an index of 110 or more was evaluated as having no practical problem.

With respect to wet grip performance, a copolymer having an index of 120 or more was evaluated as very good, a copolymer having an index of 105 or more and less than 120 was evaluated as good, a copolymer having an index of 100 or more was evaluated as having no practical problem, and a copolymer having an index less than 100 was evaluated as having a practically insufficient performance.

TABLE 5

| | | Comparative | Comparative | | | | Comparative | Comparative | Comparative |
|---|---|---|---|---|---|---|---|---|---|
| | | Example 9 | Example 10 | Example 10 | Example 11 | Example 12 | Example 11 | Example 12 | Example 13 |
| | | Comparative | Comparative | | | | Comparative | Comparative | Comparative |
| Corresponding Polymer | | Example 1 | Example 2 | Example 1 | Example 2 | Example 3 | Example 3 | Example 4 | Example 5 |
| Processability | INDEX | 100 | 95 | 102 | 97 | 91 | 80 | 94 | 97 |
| Breaking Strength | INDEX | 100 | 96 | 116 | 122 | 130 | 140 | 105 | 104 |
| Elongation at Break | INDEX | 100 | 101 | 110 | 115 | 120 | 124 | 96 | 97 |
| Low Fuel Consumption | INDEX | 100 | 145 | 160 | 157 | 140 | 118 | 139 | 142 |
| Performance | | | | | | | | | |
| Wet Grip Performance | INDEX | 100 | 108 | 107 | 109 | 114 | 120 | 109 | 108 |

TABLE 6

| | | Ex- | Ex- | Ex- | Comparative | Ex- | Ex- | Ex- | Comparative | Comparative |
|---|---|---|---|---|---|---|---|---|---|---|
| | | ample 13 | ample 14 | ample 15 | Example 14 | ample 16 | ample 17 | ample 18 | Example 15 | Example 16 |
| Cor- | | | | | | | | | | |
| responding | | | | | Comparative | | | | Comparative | Comparative |
| Polymer | | Example 4 | Example 5 | Example 6 | Example 6 | Example 7 | Example 8 | Example 9 | Example 7 | Example 8 |
| Processability | INDEX | 97 | 94 | 86 | 76 | 108 | 104 | 103 | 82 | 107 |
| Breaking | INDEX | 110 | 124 | 130 | 138 | 116 | 112 | 106 | 102 | 102 |
| Strength | | | | | | | | | | |
| Elongation at | INDEX | 107 | 109 | 113 | 119 | 110 | 110 | 107 | 107 | 101 |
| Break | | | | | | | | | | |
| Low Fuel | INDEX | 151 | 146 | 141 | 117 | 123 | 121 | 110 | 146 | 157 |
| Consumption | | | | | | | | | | |
| Performance | | | | | | | | | | |
| Wet Grip | INDEX | 108 | 113 | 117 | 121 | 104 | 103 | 101 | 73 | 89 |
| Performance | | | | | | | | | | |

As shown in Tables 3 to 6, the copolymers of Examples 1 to 9 were confirmed to have a low Mooney viscosity of the compound in producing a vulcanizate and to exhibit good processability as compared with those of Comparative Examples 1 to 8. Besides, these copolymers were confirmed to be excellent in breaking strength and elongation at break obtained in the form of a vulcanizate, and also practically good in low fuel consumption performance and wet grip performed obtained in the form of a vulcanizate.

### INDUSTRIAL APPLICABILITY

A copolymer of the present invention is industrially applicable as a material or the like of tire treads, interiors and exteriors of vehicles, anti-vibration rubbers, belts, shoes, foam bodies, and various industrial products.

1. A copolymer comprising an aromatic vinyl monomer unit, and structural units represented by the following formulas (1) to (4),
wherein, based on 100% by mass of a total amount of the structural units represented by the following formulas (1) to (4),
a content C1 of the structural unit represented by the formula (1) is 0% by mass or more and 3% by mass or less;
a content C2 of the structural unit represented by the formula (2) is 2% by mass or more and less than 20% by mass;
a content C3 of the structural unit represented by the formula (3) is 4% by mass or more and 80% by mass or less;
a content C4 of the structural unit represented by the formula (4) is 2% by mass or more and 80% by mass or less; and
a total content of the content C1 and the content C2 is 3% by mass or more and less than 20% by mass:

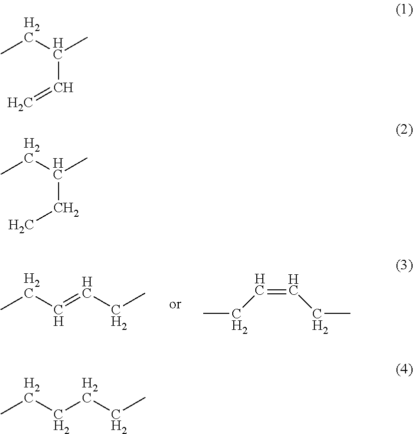

2. The copolymer according to claim 1, comprising 5.0% by mass or less of a chained aromatic vinyl monomer containing 8 or more chained aromatic vinyl monomer units.

3. The copolymer according to claim 1, comprising 5% by mass or more and 60% by mass or less of the aromatic vinyl monomer unit.

4. The copolymer according to claim 1, wherein in the structural unit represented by the formula (3), a content of a trans bond is larger than a content of a cis bond by 2% by mass or more and 30% by mass or less.

5. The copolymer according to claim 1, wherein a sum of the content C2 of the structural unit represented by the formula (2) and the content C4 of the structural unit represented by the formula (4) is 30% by mass or more and 85% by mass or less.

6. The copolymer according to claim 1, having a weight average molecular weight measured by gel permeation chromatography (GPC) of 100,000 or more and 1,000,000 or less.

7. The copolymer according to claim 1, having a modification ratio of 30% or more and 99% or less.

8. The copolymer according to claim 1, having a silicon content of 30 to 200 ppm.

9. The copolymer according to claim 1, wherein the contents C1 to C4 of the structural units represented by the formulas (1) to (4) satisfy the following formula (A):
0.2<(C2+C4)/(C1+C2+C3+C4)<0.85 Formula (A):

10. A copolymer composition comprising:
100 parts by mass of the copolymer according to claim 1; and
1 to 60 parts by mass of a rubber softener.

11. A rubber composition comprising:
a rubber component; and
5.0 parts by mass or more and 150 parts by mass or less of a filler based on 100 parts by mass of the rubber component,
wherein the rubber component contains 10 parts by mass or more of the copolymer according to a claim 1 based on 100 parts by mass of a total amount of the rubber component.

12. The copolymer according to claim 2, comprising 5% by mass or more and 60% by mass or less of the aromatic vinyl monomer unit.

13. The copolymer according to claim 2, wherein in the structural unit represented by the formula (3), a content of a trans bond is larger than a content of a cis bond by 2% by mass or more and 30% by mass or less.

14. The copolymer according to claim 3, wherein in the structural unit represented by the formula (3), a content of a trans bond is larger than a content of a cis bond by 2% by mass or more and 30% by mass or less.

15. The copolymer according to claim 12, wherein in the structural unit represented by the formula (3), a content of a trans bond is larger than a content of a cis bond by 2% by mass or more and 30% by mass or less.

16. The copolymer according to claim 2, wherein a sum of the content C2 of the structural unit represented by the formula (2) and the content C4 of the structural unit represented by the formula (4) is 30% by mass or more and 85% by mass or less.

17. The copolymer according to claim 3, wherein a sum of the content C2 of the structural unit represented by the formula (2) and the content C4 of the structural unit represented by the formula (4) is 30% by mass or more and 85% by mass or less.

18. The copolymer according to claim 4, wherein a sum of the content C2 of the structural unit represented by the formula (2) and the content C4 of the structural unit represented by the formula (4) is 30% by mass or more and 85% by mass or less.

19. The copolymer according to claim 12, wherein a sum of the content C2 of the structural unit represented by the formula (2) and the content C4 of the structural unit represented by the formula (4) is 30% by mass or more and 85% by mass or less.

20. The copolymer according to claim 13, wherein a sum of the content C2 of the structural unit represented by the formula (2) and the content C4 of the structural unit represented by the formula (4) is 30% by mass or more and 85% by mass or less.
